(19) United States
(12) Patent Application Publication
(10) Pub. No.: US 2004/0128269 A1
(43) Pub. Date: Jul. 1, 2004

(54) System and method for managing data through families of inter-related metadata tables

(76) Inventors: Charles A. Milligan, Golden, CO (US); Thomas Nelson Noland, Louisville, CO (US); Leslie K. Hodge, Westminster, CO (US)

Correspondence Address: STORAGE TECHNOLOGY CORPORATION, One StorageTek Drive, Louisville, CO, 80028-4309, US

(21) Appl. No.: 10/330,875

(22) Filed: Dec. 27, 2002

(51) Int. Cl. G06F 7/00

(52) U.S. Cl. 707/1

(57) ABSTRACT

A system and method for providing families of inter-related copies of metadata in which the copies of metadata are logically linked. With the system and method, a mapping table or portion of a mapping table used to manage instant copies of data, i.e. a metadata table, may have multiple identical copies of the metadata table that form a family of inter-related metadata tables. These copies of the metadata table are guaranteed, through the mechanisms of the system and method, to be consistent with each other. Changes to any metadata table in the family are propagated to all the other metadata tables in the family regardless of the physical location at which the metadata table is stored. Thus, the copies of the metadata table may be distributed to remote physical locations and be used to access the same set of data stored in one physical location, while remaining consistent with each other copy of the metadata table stored at other physical locations.

### RELATED APPLICATIONS

The present application is related to commonly assigned and copending U.S. patent application entitled “PROCESSING DISTRIBUTION USING INSTANT COPY,” Ser. No. 10/147,831, filed on May 17, 2002 U.S. patent application entitled “APPARATUS AND METHOD FOR INSTANT COPY OF DATA,” Ser. No. 09/884,822 and U.S. patent application entitled “APPARATUS AND METHOD FOR INSTANT COPY OF DATA IN A DYNAMICALLY CHANGEABLE VIRTUAL MAPPING ENVIRONMENT,” Ser. No. 09/884,687, both of which were filed on Jun. 19, 2001 U.S. patent application entitled “APPARATUS AND METHOD FOR CUSTOMIZATION OF ENVIRONMENTS USING INCREMENTAL CHANGES TO METADATA,” Ser. No. 10/179,557, Attorney Docket Number 2002-020-DSK, filed on Jun. 25, 2002, U.S. patent application Ser. No. 10/307,797 (Attorney Docket No. 2002-078-DSK) entitled “INDEPENDENT DISTRIBUTED METADATA SYSTEM AND METHOD,” filed on Dec. 2, 2002, all of the above applications being hereby incorporated by reference.

### BACKGROUND OF THE INVENTION

1. Technical Field

The present invention describes a method for managing data through the use of metadata. More specifically, the present invention is directed to a system and method of families of inter-related tables of metadata in which the tables are logically linked. When certain types of changes are made to any member of such a family these changes will be propagated to all members of that family. This mechanism is particularly suited to use in distributed systems, where diverse elements of the system would each contain logically linked metadata tables that are members of some such family of tables.

2. Description of Related Art

In known storage subsystems that make use of instant copy operations, such as the Snapshot instant copy mechanism available from Storage Tek, Inc., data files are received from a processor and stored in back-end data storage devices by mapping the processor assigned data file identifier to a logical address that identifies the physical storage location of the data. This mapping allows instant copies of data files by creating duplicate data file pointers that reference the original data files. In this dynamically mapped virtual data storage system, the data files are referred to as a collection of “virtual tracks” and each data file is identified by unique virtual track addresses (VTAs). More information about the Snapshot instant copy mechanism may be found in the incorporated U.S. patent application Ser. No. 09/884,822 entitled “APPARATUS AND METHOD FOR INSTANT COPY OF DATA.”

While this instant copy operation works well within the confines of a local storage subsystem, it is often necessary to provide access to locally stored data to computing devices that are remote to the storage subsystem. That is, it is often necessary for various computing devices in a distributed data processing system to make use of the same set of data stored in a local storage subsystem.

In distributed data processing systems, multiple local copies of the same data element are often stored in different physical locations in order to allow computing devices at those physical locations access to the data element. For example, if a first computing device located in Chicago, Ill. has a particular set of data on its storage subsystem and a second computing device in Los Angeles, Calif. wishes to make use of this set of data, the second computing device must have its own local copy of the data stored in its local storage subsystem which it can then operate on.

There are several drawbacks to keeping multiple copies of data. One drawback is increased resource consumption. These resources include transmission bandwidth, physical memory, and the like. That is, data must be transferred from the original location, thus incurring transmission expense. Once the data arrives at the new location, memory must be allocated for it.

Another problem with the current system of maintaining multiple local copies of data is that it becomes difficult to manage the multiple existing copies. For example, the various copies of the data must be maintained such that they are consistent with one another. As a result, whenever any data in any of the copies of the data is changed, the changes must be reported to every other computing device having a copy of that data. This leads to a variety of technical difficulties that must be handled. Furthermore, it creates a large amount of processing overhead to simply manage the various copies of the data.

Thus, it would be beneficial to have a system and method for allowing distributed access to data without requiring multiple copies of the data. Furthermore, it would be beneficial to have a system and method in which management of changes to data is simplified.

### SUMMARY OF THE INVENTION

The present invention provides a system and method for providing families of inter-related copies of metadata in which the copies of metadata are logically linked. That is, a mapping table or portion of a mapping table used to manage instant copies of data, i.e. a metadata table, may have multiple identical copies of the metadata table that form a family of inter-related metadata tables. These copies of the metadata table are guaranteed, through the mechanisms of the present invention, to be consistent with each other. Changes to any metadata table in the family are propagated to all the other metadata tables in the family regardless of the physical location at which the metadata table is stored. Thus, the copies of the metadata table may be distributed to remote physical locations and be used to access the same set of data stored in one physical location, while remaining consistent with each other copy of the metadata table stored at other physical locations.

The metadata may consist of offsets, pointers, bitmaps, timestamps, file sizes, and/or other information. The key feature for the purposes of the present invention is that the metadata can be used to derive the physical location on the storage device of its associated data. This may be a track, cylinder, or other unit of storage on a storage medium. The metadata may indicate the size or granularity of the physical unit of storage as well as the number of consecutive physical units of storage used to store the data.

In a preferred embodiment, the metadata tables forming a family are identical copies of each other and include pointers to units of storage of a predetermined size, such as tracks on a disk drive in a storage subsystem. Either the metadata or the application using the metadata contains information regarding the physical location of the storage device.

In the apparatus and method of the present invention, metadata tables are used to reference the physical locations of data. By changing an entry in a metadata table, different data will be accessed. Each copy of a metadata table in a particular family is logically linked to each of the other copies of the metadata table in that family. By “logically linked” what is meant is that there is a mechanism for updating each copy of the metadata table when the physical data location to which a metadata table entry points is changed. Thus, any changes made to a metadata table of a particular family will be reflected in all tables of that family. The update mechanism of the present invention, in a preferred embodiment, involves a locking mechanism and a listing of locations of copies of the metadata table. When an application desires to change a metadata entry in a locally stored metadata table, the application must first request a lock of the physical storage location associated with the metadata entry. Once the lock is obtained, the data at the physical storage location and the corresponding metadata entry in the local copy of the metadata table may be modified.

After the metadata entry is modified, the changes are propagated to the other copies of the metadata table by sending the changes to the locations of these other copies. The locations of these other copies are maintained in a data structure in association with the original copy of the metadata table. In a preferred embodiment, a message is broadcast to each of the locations of the other copies of the metadata table in the family of metadata tables corresponding to the changed metadata table, instructing them to update their local copies of the metadata table and forwarding the changes.

A storage subsystem controller in each of these locations receives this message and performs the necessary actions to update their locally stored copy of the metadata table and responds with an acknowledgement when the update is completed. Once the data source computing device receives acknowledgements from each of the locations of copies of the metadata table, the lock on the entry in the original metadata table may be released for use by another application on the same or a different computing device.

Thus, with the update mechanism of the present invention, ach copy of the metadata in a particular family is kept consistent with the other copies of metadata in that family so that all reference the same physical data locations. In a distributed system, metadata tables from a particular family may be allocated to a number of different locations independent of the actual data with which the metadata is associated and still be assured that each copy of the metadata references the same physical data locations on a particular storage device.

These families of metadata tables may be analogous to the mapping tables in the Snapshot mechanism described in the incorporated U.S. patent application Ser. No. 09/884,822 entitled “APPARATUS AND METHOD FOR INSTANT COPY OF DATA.” In the Snapshot mechanism, when an instant copy is performed, a new mapping is created so that there are two sets of pointers referencing each physical data storage unit (track, cylinder, etc. on a disk drive). When the contents of a physical data storage unit need to be changed, a copy of the contents is placed in a new physical data storage unit, the appropriate pointers are changed to point to the new physical data storage unit, and the data at the new location is then changed.

One implementation of the present invention is to provide a mechanism for distributing the mapping tables used for instant copies, such as Snapshot instant copies, in a distributed data processing system. In such an implementation, a plurality of computing devices in the distributed data processing system contain a mapping table, i.e. metadata table, for the same family of metadata tables. When an instant copy is performed, a new family of metadata tables is constructed and each element of the distributed system receives a new table for that family. When an update to data is performed, the contents of the physical data storage unit (track, cylinder, etc.) are placed in a new physical data storage unit, the appropriate references for an entire family of metadata tables are changed to refer to the new physical data storage unit, and the data at the new location may then be changed.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a network computing environment in which the present invention may be implemented;

FIG. 2 is an exemplary block diagram of a storage subsystem in accordance with a preferred embodiment of the present invention;

FIG. 3 is an exemplary diagram illustrating a client device in which the present invention may be implemented;

FIG. 4 is an exemplary diagram illustrating metadata table-storage device model used with the present invention;

FIG. 5 is an exemplary diagram illustrating an overall methodology of the present invention;

FIG. 6 is an exemplary diagram illustrating a distributed system prior to modification of data in the physical tracks of a storage subsystem in accordance with the present invention;

FIG. 7 is an exemplary diagram illustrating the distributed system of FIG. 6 at a state of preparation for modification of data in the physical tracks in accordance with the present invention;

FIG. 8 is an exemplary diagram illustrating the resulting distributed system obtained through use of the present invention; and

FIG. 9 is a flowchart outlining an exemplary operation of the present invention.

### DETAILED DESCRIPTION OF THE PREFERRED EMBODIMENTS

The present invention describes a method for managing data through the use of metadata. The present invention consists of a system and method of families of inter-related tables of metadata in which the tables are logically linked. When certain types of changes are made to any member of such a family these changes will be propagated to all members of that family. The present invention is especially advantageous when used in a distributed computing environment, such as a network. Accordingly, the detailed description of the embodiments of the present invention will first provide a brief explanation of an exemplary distributed computing environment in which the present invention may be implemented and then will discuss the details of how the present invention is implemented in such a distributed computing environment.

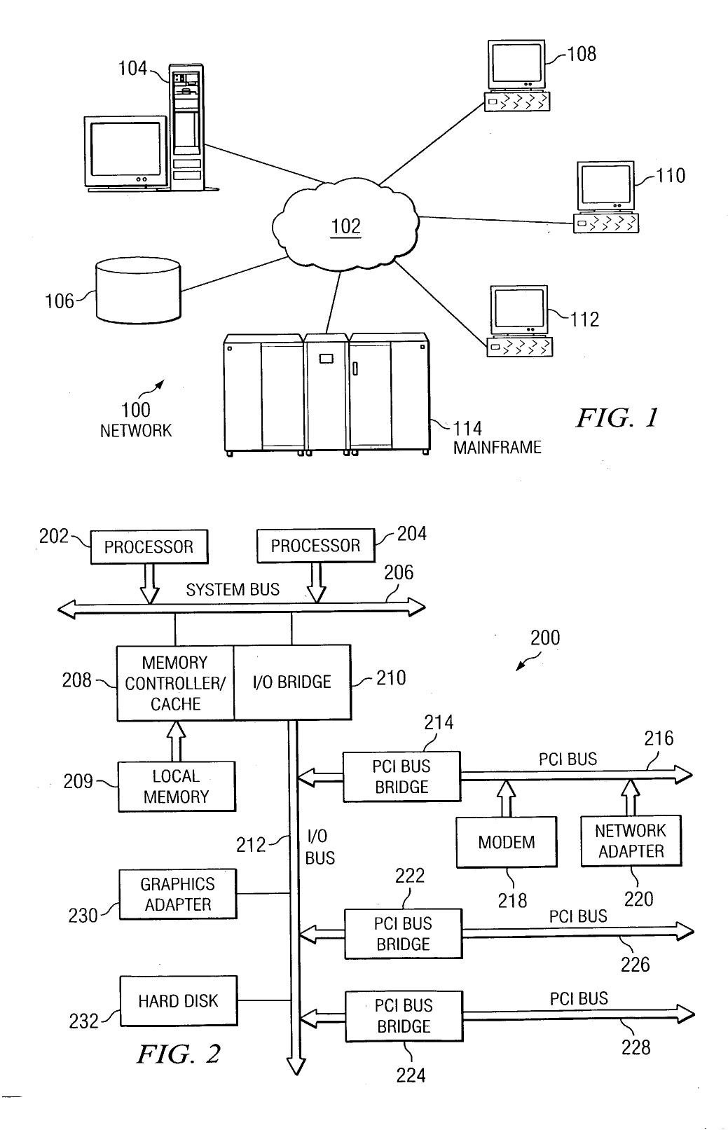

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with mainframe 114 and storage unit 106. In addition, clients 108, 110, and 112 also are connected to network 102. These clients 108, 110, and 112 may be, for example, personal computers or network computers. In the depicted example, server 104 and mainframe 114 may provide data, such as boot files, operating system images, and applications to clients 108-112. In addition, mainframe 114 may host one or several virtual servers. Clients 108, 110, and 112 are clients to server 104 and mainframe 114. Network data processing system 100 may also include additional servers, clients, and other devices not shown (e.g., printers).

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary and could indeed be a mainframe architecture rather than the depicted architecture. In addition, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

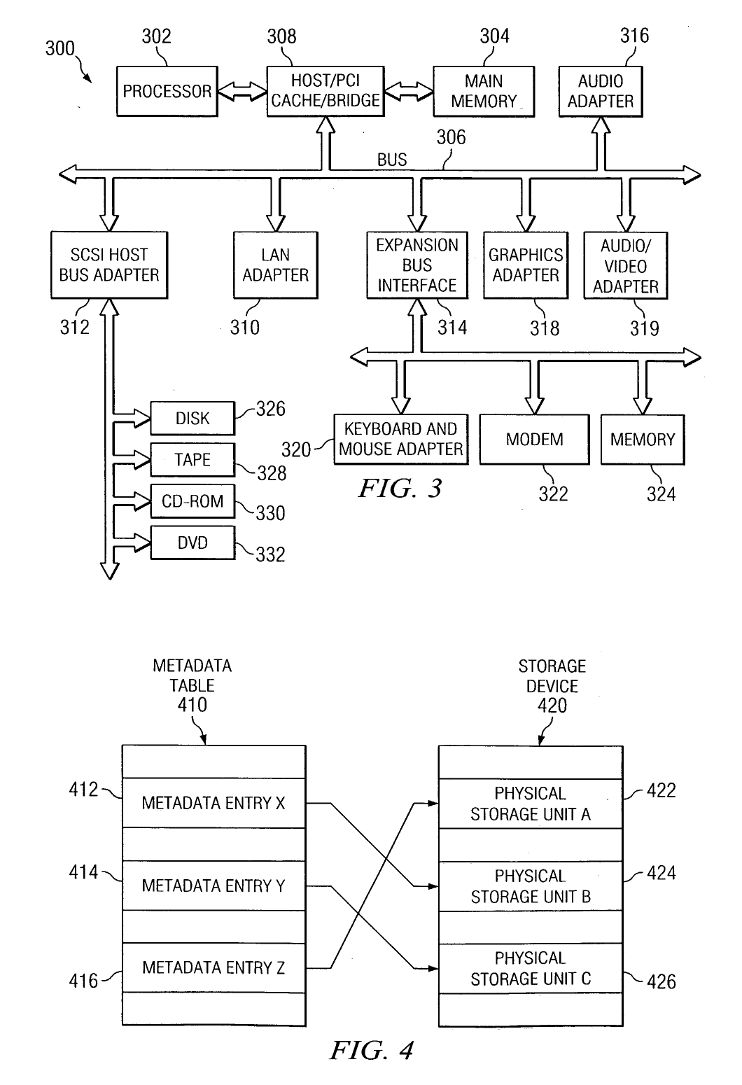

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As discussed previously, the present invention describes a mechanism for managing data through the use of metadata in metadata tables. The present invention consists of a system and method of families of inter-related metadata tables in which the metadata tables are logically linked so that when changes are made to any member of such a family, these changes will be propagated to all members of that family.

With the system and method of the present invention, metadata, which is associated with data at one or more data source locations, may be distributed independently of the data and manipulated independently to generate various computing environments, create local copies or data sets and/or perform analysis to enable other actions. Independent distribution of metadata is described in co-pending and commonly assigned U.S. patent application Ser. No. 10/307,797 (Attorney Docket No. 2002-078-DSK) entitled “Independent Distributed Metadata System and Method.”

From the copy of metadata, a user may create a metadata data structure for defining a local data set, new computing environment, etc. The copy of metadata points to the physical data stored in the originating location. When changes to this original data occur, a copy of the data is made and stored to a new data storage location. The metadata for that data is then changed so as to point to the new data location. Thereafter, the data in the new data location may be changed. In this way, the original data is preserved.

With independently distributed copies of the metadata, while the original metadata is updated to point to the new physical storage location of the new version of the data, the independent copies are not. This may give rise to a problem in which copies of metadata may be inconsistent due to the copies being distributed to a plurality of remotely located computing devices. The present invention is directed to solving this potential problem by providing a mechanism for ensuring consistency between the copies of metadata.

The present invention is based on the concept of inter-related families of metadata in metadata tables where each member of the family is updated to point to the new physical storage location of the new version of the data. With the families of inter-related metadata tables described in the present invention, each copy of the metadata table is logically linked to each of the other copies of the metadata table in the family. By “logically linked” what is meant is that there is a mechanism for updating each copy of the metadata table when there are changes to the physical data location to which the metadata in the metadata table points.

In one exemplary embodiment, the consistency of copies of metadata and the proliferation of updates to the various copies of metadata involves using locks. That is, when one of the metadata tables from a particular family is being updated, the computing system that is performing the update requests a lock for the affected physical data locations in the storage device. From that point on no other metadata tables in the family can be used to update that physical data location until all tables in the family has been changed to reflect the initial update of the data in the physical data location and the lock has been released.

Various other methods in addition to, or in replacement of, locks may be used for ensuring consistency amongst the copies of metadata in a distributed system may be used without departing from the spirit and scope of the present invention. The primary requirement is that, once an update to data is begun, no other metadata table may be used to modify the data at a particular physical data location until after all metadata tables in a family of metadata tables are updated.

Regardless of the particular update mechanisms used, each copy of the metadata in a family is kept consistent with the other copies of metadata in that family so that all are pointing to the same physical data locations. In this way, metadata may be distributed to a number of different independent locations independent of the actual data with which the metadata is associated and still be assured that each copy of the metadata references the same physical data locations.

While the present invention will be described in terms of ensuring consistency of the pointers to the physical data locations in the copies of the metadata, other portions of the metadata may be kept consistent using the mechanisms of the present invention as well. For example, redundancy information, data segment size information, data descriptions, time stamps, versioning information, and the like, may be kept consistent using the present invention. In short, any metadata or portions thereof may be kept consistent amongst the plurality of copies of the metadata using the update mechanisms described herein.

The various logically linked copies of metadata may be used locally for many different reasons. For example, the metadata itself may be used to generate new local data sets, new computing environments, web pages, and the like. In this way, the metadata may be manipulated locally to generate these new data structures without having to have a copy of the actual data. Only after the new data structure is created and is ready to be implemented locally will it be necessary to retrieve the data associated with the metadata.

For example, a user may obtain a copy of metadata and use this metadata, at a remote location from the data source location, to create a computing environment, such as a virtual server, web page or the like. The computing environment created by the user consists entirely of metadata and does not include the actual data with which the metadata is associated. In this way, different users may have copies of the metadata and use it to generate their own computing environments without having to have access to the actual data.

When the computing environment is to be implemented in a computing device, such as a server or servers on a network, the metadata defining the computing environment may be uploaded to the computing device. The computing device may then perform a verification of the metadata through the update mechanism that insures all metadata tables within a family remain consistent with each other. The device may then download the corresponding data from the data source locations specified in the metadata.

Thereafter, the computing environment may be made available for use via the server, the metadata and the data associated with the metadata. In this way, only when a computing environment is to be implemented is any transfer of data, or even the presence of the data, required. Prior to actual implementation of the computing environment, functions are performed based on the metadata only.

Alternatively, remote locations may be provided with metadata tables according to the present invention, upon which local applications operate to determine actions to perform. For example, an application on a local computing device may interact with a user to obtain information that is used to determine a subset of the metadata table required for performing a desired action. From this subset of the metadata table, the actual data may be retrieved from the data source or determinations regarding actions to be performed by the application may be made. For example, if the data required to provide the desired action would result in excessive amounts of data being transmitted, large delay, sensitive data being transmitted, or the like, a determination may be made to send the application to the data source which may then execute the application on the data at the data source.

For purposes of the present description, it will be assumed that the metadata structures and operations on these metadata structures are performed to generate a new computing environment. However, as noted above, the present invention is not limited to use in generating new computing environments. Any application of the present invention that may benefit from the distribution and manipulation of metadata data structures independent of the data with which the metadata is associated, is intended to be within the spirit and scope of the present invention.

The concepts and mechanisms of the present invention may be used in conjunction with, and may build on, the features and mechanisms described in co-pending and commonly assigned U.S. patent applications Ser. No. 10/150,174, Ser. No. 10/147,831, and Ser. No. 10/179,557 (Attorney Docket Nos. 2002-018-DSK, 2002-019-DSK and 2002-020-DSK), which have been incorporated herein by reference. In these applications, mechanisms are described for generating new server instances using an instant copy operation and customizing these new server instances. The present invention expands upon this concept by providing a mechanism to not only generate copies and customized versions of server instances, but to do so independent of the underlying server instance data and its associated metadata. As a result, with the present invention, computing environment developers may generate computing environments using localized versions of metadata independent of any changes to the actual data and/or metadata at the source.

FIG. 4 exemplifies the metadata table-data storage model used in the present invention. As shown in FIG. 4, the metadata table 410 includes a plurality of entries 412-416 that point to physical locations 422-426 of a storage device 420 where data corresponding to the metadata table entries 412-416 is located. The metadata may consist of offsets, pointers, bitmaps, timestamps, file sizes, and/or other information. The key feature for the purposes of the present invention is that the metadata can be used to derive the physical location on the storage device of its associated data. This may be a track, cylinder, or other unit of storage on a magnetic tape storage medium, magnetic disk storage medium, optical storage medium, removable storage medium, memory, or the like. The metadata may also indicate the size or granularity of the physical unit of storage along with the number of sequential units involved in the storage of the desired information.

In a preferred embodiment, the metadata tables include pointers to units of storage of a predetermined size, such as tracks on a disk drive in a storage subsystem. When a calling application wishes to access data on the storage device 420, the calling application looks up the metadata corresponding to the files it requires in the metadata table 410. From the metadata in the metadata table 410, the calling application identifies the addresses of the tracks on which the files reside in the storage device 420 and reads the data from the tracks of the storage device 420.

The metadata table 410 may be obtained, for example, using an instant copy operation or the like. An exemplary instant copy operation is described in U.S. patent application Ser. No. 09/884,822, (Attorney Docket No. 2001-005-DSK) entitled “Apparatus and Method for Instant Copy of Data.” An instant copy mechanism of this type may either be used as described in the above patent, or may be augmented in such a manner so as to provide additional information for each entry in the metadata table.

With the present invention, there may be multiple copies of metadata table 410 in various different physical locations. That is, copies of the metadata table 410 may be distributed to computing devices in a distributed data processing system independently of the data stored in storage device 420. Users of the computing devices to which the copies of the metadata table 410 are distributed may use these copies of metadata table 410 to generate local data sets, generate new computing environments, or even change the data in the storage device 420. Thus, with a plurality of independent copies of the metadata table 410 and the ability to change the data stored in the storage device 420, using an instant copy operation, for example, there is the possibility that all copies of the metadata may not remain consistent with one another without the aide of an additional mechanism for ensuring consistency. In other words, some copies of the metadata table 410 may point to physical locations 422-426 while others that have undergone some change may point to different physical locations of the storage device 420 or another storage device.

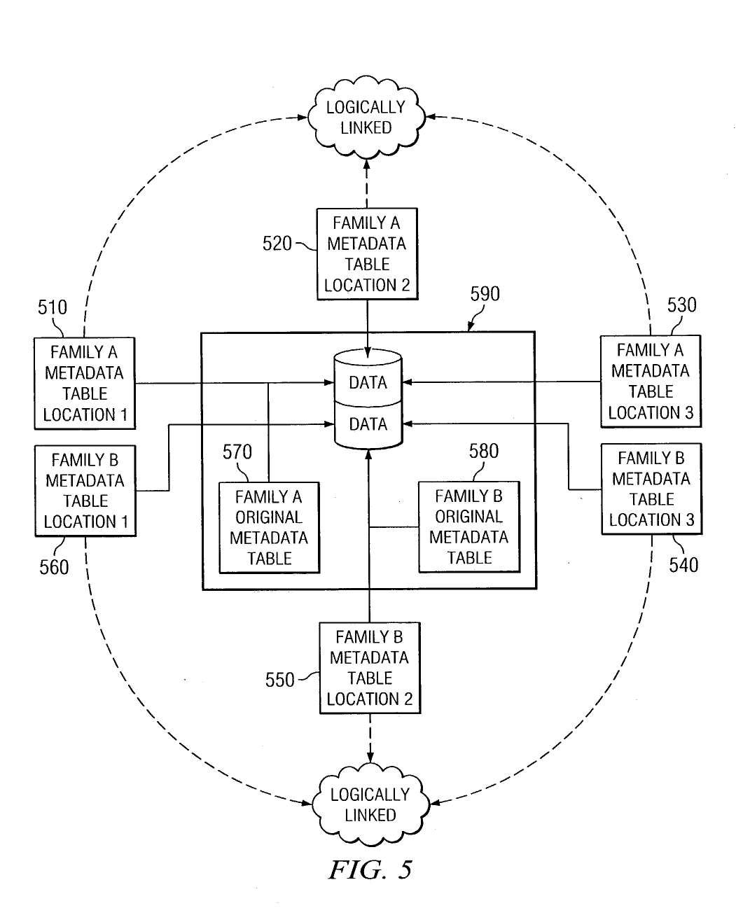

FIG. 5 illustrates the basic concept of the present invention. As shown in FIG. 5, two families of metadata tables, family A and family B are illustrated with copies of the metadata tables 510-580 for each family being distributed to three different locations.

In the simplest form of the present invention, the metadata tables within each particular family are identical. Each of the metadata tables in family A is identical to every other metadata table in family A and is guaranteed to always be identical through a logical linking mechanism that logically links all of the copies of the metadata tables within a family of metadata tables.

This does not necessarily need to be true. The metadata tables within each particular family need not necessarily be identical. The essential characteristic of the metadata tables of a specific family is that their corresponding entries each refer to the same physical data on the storage device. When a file is requested from any two applications or devices that use separate metadata tables from the same family, the same physical storage units must be accessed and the same physical data must be returned. The metadata from corresponding entries of two metadata tables from the same family may be very different, even the mechanism for locating and retrieving the physical data may be-different, as long as each entry accesses the same physical storage units and returns the same physical data.

Any change made to a metadata entry in one of the copies of the metadata tables 510-580 must be propagated to all the other metadata tables of the same family. In an exemplary implementation of the invention, one possible method for ensuring that all metadata tables of a family are updated is to use a central management mechanism for coordinating data updates. This mechanism would be responsible for maintaining a list of “locks” for each physical unit of data storage on the storage device (e.g. each physical track on a disk drive). The mechanism would also keep track of all of the metadata tables.

Before entries in a metadata table, such as metadata table 510, can be changed, the application on the computing device desiring to make the change would access the management mechanism with a request to update data on some set of tracks. The mechanism would lock the affected tracks and make the changes to the physical data.

While the locks are still set the entries in the metadata table 510 can be changed. Then these changes can be migrated to the other metadata tables 520-530 and 570 in the family. When all the metadata tables 510-530 and 570 in the family are updated, then the lock is released and made available to any other application on any other computing device in the distributed data processing system.

The manner by which the changes to a copy of the metadata table are proliferated amongst the other copies of the metadata table in the same family, in a preferred embodiment, is to broadcast a message via a management mechanism to known locations of the other copies of the metadata table. When an application makes a change to its local copy of the metadata table, the application forwards that change to the management mechanism which then retrieves the locations of the other copies of the metadata table in the same family as the local copy that was changed, and broadcasts the changes along with an update instruction to the identified locations of the other copies of the metadata table. The computing devices at these locations receive the instruction and the changes and perform the necessary operations to update the local copy of the metadata table and return an acknowledgement that the updates have been completed. Once the management mechanism receives an acknowledgement from each of the locations, the locks on the physical tracks may be released.

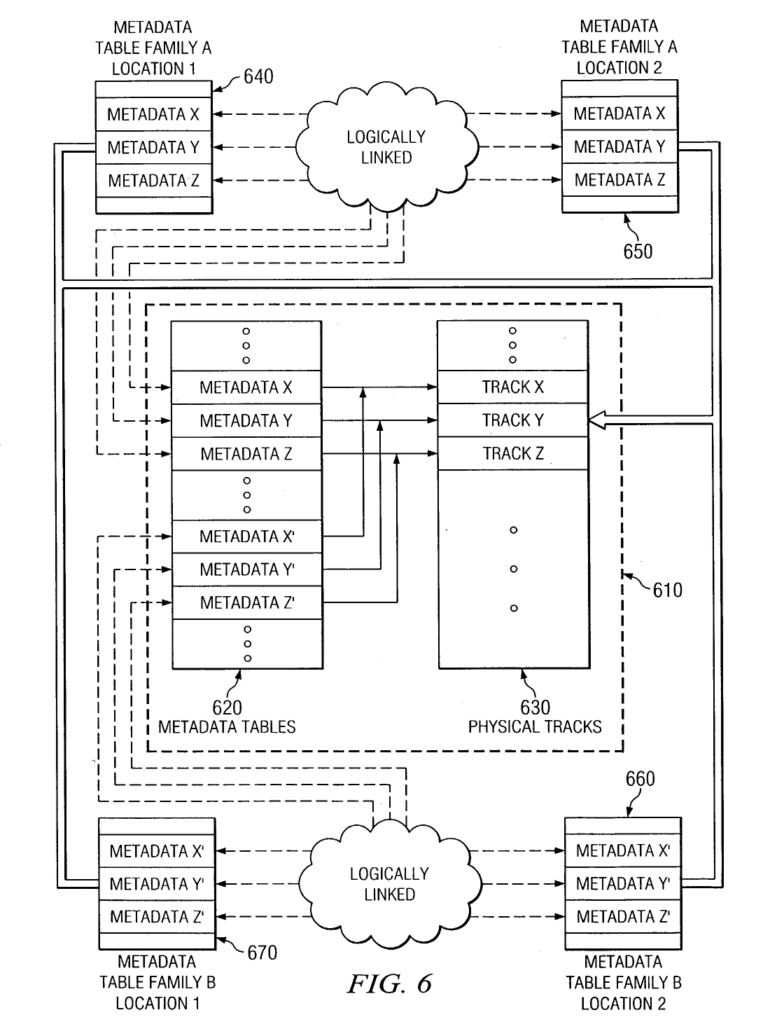

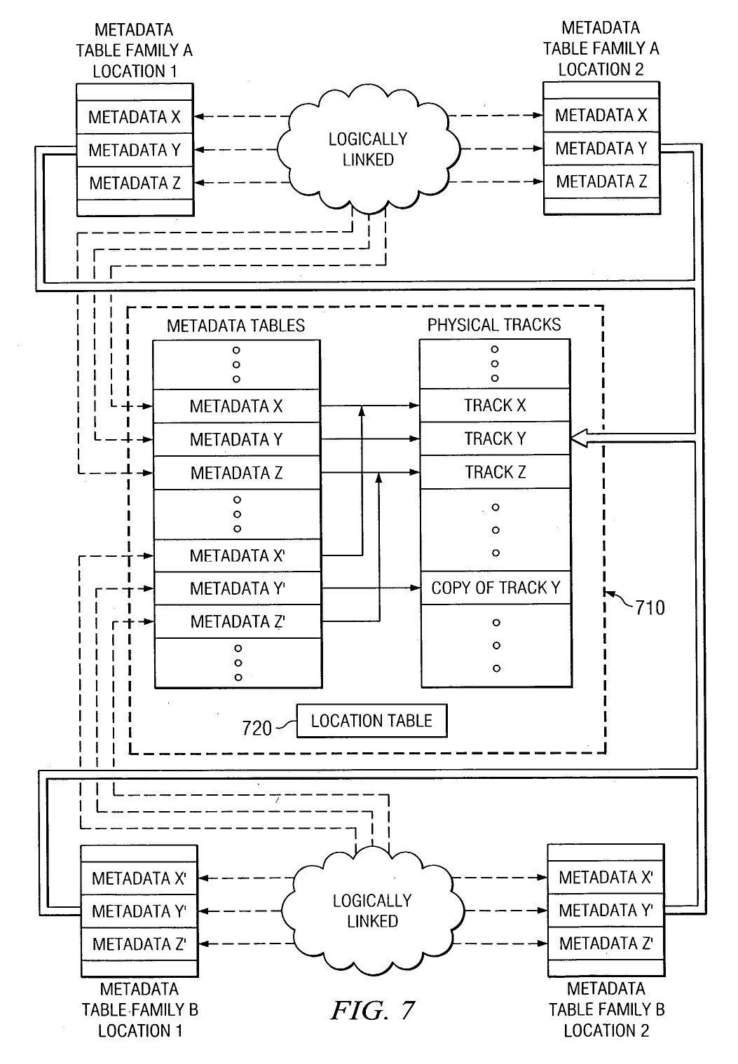

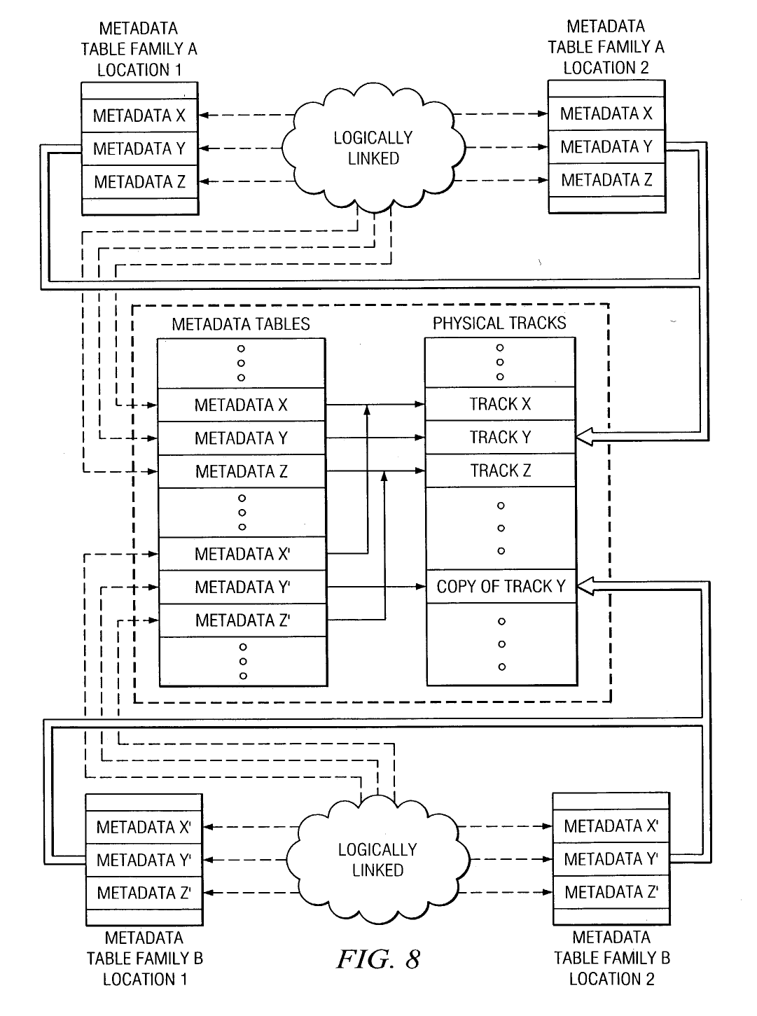

FIGS. 6-8 illustrate various stages of a distributed system during a change to the data in a data storage device according to the present invention. FIG. 6 illustrates the distributed system prior to a data update. FIG. 7 illustrates the distributed system during preparation for the update to the data. FIG. 8 illustrates the distributed system after the data has been updated and the updates to the metadata table have been propagated to each of the copies of the metadata table for a family of metadata tables.

Referring to FIG. 6, the distributed system illustrated in FIG. 6 includes a data source computing device 610 where original copies of metadata tables 620 are stored along with the corresponding data stored in physical tracks 630 of storage media. As shown in FIG. 6, the metadata of the metadata tables 620 point to tracks X, Y and Z. The metadata X′, Y′, Z′ are an instant copy of the metadata X, Y and Z obtained, for example, through the use of an instant copy operation such as Snapshot. As such, the metadata X, Y, Z and X′, Y′, Z′ point to data tracks X, Y and Z.

Also shown in FIG. 6 are copies 640-670 of the metadata tables 620 at two different locations, Location 1 and Location 2. These copies of the metadata tables 620 are logically linked to each other and to the original copy of the metadata tables 620 by the mechanisms of the present invention for governing changes to the copies of the metadata tables. Metadata table 640, 650 and a subset of metadata table 620 form metadata table family A. Metadata table 660, 670 and a another subset of metadata table 620 form metadata table family B. Metadata family B would be the result of an instant copy. The resulting metadata table subset (Metadata X′, Metadata Y′, Metadata Z′, etc.) was then copied and distributed to Location 1 and Location 2. FIG. 7 illustrates the same distributed system shown in FIG. 6 but at a state where a change to the data stored in the physical tracks 630 is preparing to be performed. As shown in FIG. 7, a copy of the data track Y 710 is created in the physical tracks in preparation of a modification to the data stored in track Y. The modifications to the data in track Y are actually performed on the copy of track Y 710 rather than the original track Y in order to preserve the original data.

At the state shown in FIG. 7, a lock is obtained on the track Y and a copy of the track Y 710 is created. Changes are then made to the copy of track Y 710 and the metadata Y′ is updated to point to the new copy of track Y 710. Thereafter, the locations of the other copies of the metadata tables for family B are identified in the location table 720. A message is sent to the computing devices on which these other copies of the metadata table are resident instructing them to update their local copies of the metadata table and forwarding the change information so that each copy of the metadata for family B now has the metadata Y′ pointing to the copy of the track Y 710. FIG. 8 illustrates the resulting distributed system. Note that the metadata entries Y′ from the Family B metadata tables have now been changed to point to the copy of track Y. This is analogous to the traditional instant copy method, only executed with a distributed systems methodology.

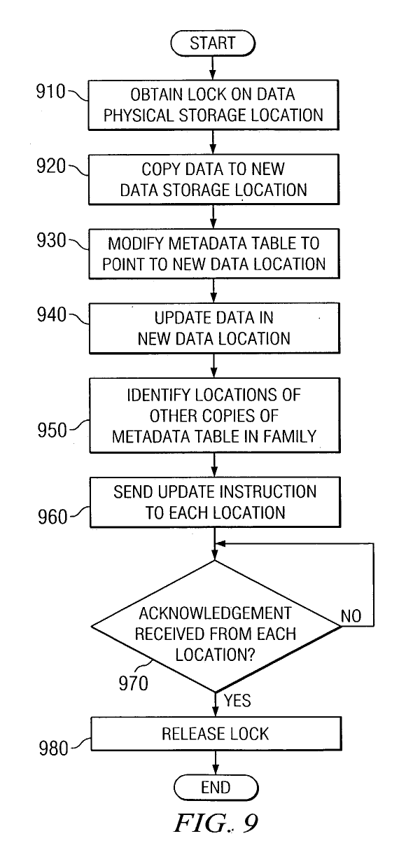

FIG. 9 is a flowchart outlining an exemplary operation of the present invention. As shown in FIG. 9, the operation starts with a lock on an appropriate data track being obtained (step 910). A copy of the data that is to be changed is stored in a new data storage location (step 920). The metadata in the metadata table is then modified to point to the new data location (step 930) and the data in the new data storage location is updated (step 940).

Thereafter, the locations of the other copies of the metadata table in the family of the metadata table that was modified are identified (step 950). A message is then broadcast to the computing systems storing each of these other copies instructing them to update their local copy of the metadata table and providing the changes for the update (step 960).

A determination is then made as to whether an acknowledgement has been received from each of these locations indicating that they have made the required updates (step 970). If not, the operation loops back to step 970 until an acknowledgement from each location is received. Although not illustrated, a time-out feature may be present in which case a rebroadcast to locations that have not sent an acknowledgement may be performed. Once an acknowledgement from each location has been received, the lock is released (step 980) and the operation is complete.

Thus, the present invention provides a mechanism for independent distribution of metadata which may be used to create computing environments independent of other copies of the metadata. More specifically, the present invention provides a mechanism that allows these independent copies of metadata to be both independent of one another in one sense but logically linked with one another so that they are maintained consistent with the most current version of the data with which the metadata is associated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of distributing metadata, comprising:
generating one or more copies of metadata, wherein the one or more copies of metadata are copies of source metadata stored in a data source computing device and wherein the one or more copies and the source metadata constitute a family of metadata copies;
modifying a portion of at least one copy of the metadata in the family of metadata copies; and
propagating the modification to the at least one copy of the metadata to all other copies of the metadata in the family of metadata copies.

2. The method of claim 1, wherein modifying a portion of at least one copy of the metadata includes modifying the metadata to point to a new data location to which the data is copied.

3. The method of claim 1, wherein propagating the modification to the at least one copy of the metadata to all other copies of the metadata in the family of metadata copies includes:
identifying one or more locations of the other copies of the metadata in the family of metadata copies; and
sending an update instruction to the one or more locations indicating the modification.

4. The method of claim 1, wherein modifying a portion of at least one copy of the metadata in the family of metadata copies includes:
obtaining a lock on a physical storage location of data associated with the portion of at least one copy of the metadata;
modifying the data at the physical storage location to generate modified data; and
modifying the portion of at least one copy of the metadata to point to the modified data.

5. The method of claim 4, wherein the physical storage location is a location to which a copy of data stored in an original physical storage location, to which the portion of at least one copy of the metadata originally pointed, is written.

6. The method of claim 4, wherein modifying the data at the physical storage location includes:
copying the data at the physical storage location to a new physical storage location; and
modifying the copy of the data in the new physical storage location, wherein modifying the portion of at least one copy of metadata to point to the modified data includes modifying the portion of at least one copy of metadata to point to the new physical storage location.

7. The method of claim 6, wherein propagating the modification to the at least one copy of the metadata to all other copies of the metadata in the family of metadata copies includes modifying all other copies of the metadata in the family of metadata copies to point to the new physical storage location.

8. The method of claim 3, wherein identifying the one or more locations of the other copies of the metadata in the family of metadata copies includes retrieving the one or more locations from a data structure used to keep track of locations of copies of metadata.

9. The method of claim 4, further comprising:
maintaining a list of locks for each physical storage location of a data storage device; and
maintaining a list of locations of all copies of the metadata.

10. The method of claim 4, further comprising:
releasing the lock only when all copies of the metadata in the family of metadata families have been updated to point to the modified data.

11. The method of claim 4, further comprising:
sending an update instruction to each location where a copy of the metadata in the family of metadata copies is located;
determining if each location has transmitted an acknowledgement of completion of updating a local copy of the metadata; and
releasing the lock only when each location has transmitted an acknowledgement of completion of updating a location copy of the metadata.

12. A system for distributing metadata, comprising:
means for generating one or more copies of metadata, wherein the one or more copies of metadata are copies of source metadata stored in a data source computing device and wherein the one or more copies and the source metadata constitute a family of metadata copies;
means for modifying a portion of at least one copy of the metadata in the family of metadata copies; and
means for propagating the modification to the at least one copy of the metadata to all other copies of the metadata in the family of metadata copies.

13. The system of claim 12, wherein the means for modifying a portion of at least one copy of the metadata includes means for modifying the metadata to point to a new data location to which the data is copied.

14. The system of claim 12, wherein the means for propagating the modification to the at least one copy of the metadata to all other copies of the metadata in the family of metadata copies includes:
means for identifying one or more locations of the other copies of the metadata in the family of metadata copies; and
means for sending an update instruction to the one or more locations indicating the modification.

15. The system of claim 12, wherein the means for modifying a portion of at least one copy of the metadata in the family of metadata copies includes:
means for obtaining a lock on a physical storage location of data associated with the portion of at least one copy of the metadata;
means for modifying the data at the physical storage location to generate modified data; and
means for modifying the portion of at least one copy of the metadata to point to the modified data.

16. The system of claim 15, wherein the physical storage location is a location to which a copy of data stored in an original physical storage location, to which the portion of at least one copy of the metadata originally pointed, is written.

17. The system of claim 15, wherein the means for modifying the data at the physical storage location includes:
means for copying the data at the physical storage location to a new physical storage location; and
means for modifying the copy of the data in the new physical storage location, wherein modifying the portion of at least one copy of metadata to point to the modified data includes modifying the portion of at least one copy of metadata to point to the new physical storage location.

18. The system of claim 17, wherein the means for propagating the modification to the at least one copy of the metadata to all other copies of the metadata in the family of metadata copies includes means for modifying all other copies of the metadata in the family of metadata copies to point to the new physical storage location.

19. The system of claim 14, wherein the means for identifying the one or more locations of the other copies of the metadata in the family of metadata copies includes means for retrieving the one or more locations from a data structure used to keep track of locations of copies of metadata.

20. The system of claim 15, further comprising:
means for maintaining a list of locks for each physical storage location of a data storage device; and
means for maintaining a list of locations of all copies of the metadata.

21. The system of claim 15, further comprising:
means for releasing the lock only when all copies of the metadata in the family of metadata families have been updated to point to the modified data.

22. The system of claim 15, further comprising:
means for sending an update instruction to each location where a copy of the metadata in the family of metadata copies is located;
means for determining if each location has transmitted an acknowledgement of completion of updating a local copy of the metadata; and
means for releasing the lock only when each location has transmitted an acknowledgement of completion of updating a location copy of the metadata.

23. A computer program product in a computer readable medium for distributing metadata, comprising:
first instructions for generating one or more copies of metadata, wherein the one or more copies of metadata are copies of source metadata stored in a data source computing device and wherein the one or more copies and the source metadata constitute a family of metadata copies;
second instructions for modifying a portion of at least one copy of the metadata in the family of metadata copies; and
third instructions for propagating the modification to the at least one copy of the metadata to all other copies of the metadata in the family of metadata copies.

24. The computer program product of claim 23, wherein the third instructions for modifying a portion of at least one copy of the metadata include instructions for modifying the metadata to point to a new data location to which the data is copied.

25. The computer program product of claim 23, wherein the third instructions for propagating the modification to the at least one copy of the metadata to all other copies of the metadata in the family of metadata copies include:
instructions for identifying one or more locations of the other copies of the metadata in the family of metadata copies; and
instructions for sending an update instruction to the one or more locations indicating the modification.

26. The computer program product of claim 23, wherein the second instructions for modifying a portion of at least one copy of the metadata in the family of metadata copies include:
instructions for obtaining a lock on a physical storage location of data associated with the portion of at least one copy of the metadata;
instructions for modifying the data at the physical storage location to generate modified data; and
instructions for modifying the portion of at least one copy of the metadata to point to the modified data.
